(19) United States
(12) Patent Application Publication
(10) Pub. No.: US 2007/0094713 A1
(43) Pub. Date: Apr. 26, 2007

(54) System and method for managing resources and rights

(76) Inventors: Andrew Venn, Menora (AU); Gordon Dunbar, Mount Lawley (AU)

Correspondence Address: MARGER JOHNSON & MCCOLLOM, P.C., 210 SW MORRISON STREET, SUITE 400, PORTLAND, OR, 97204, US

(21) Appl. No.: 10/566,618

(22) PCT Filed: Jul. 30, 2004
(86) PCT No.: PCT/AU04/01018

§ 371 Date: Nov. 16, 2006

(30) Foreign Application Priority Data
Jul. 31, 2003 (AU) 2003903997

(51) Int. Cl. H04L 9/32

(52) U.S. Cl. 726/4

(57) ABSTRACT

A system for managing resources and/or rights comprising: a set of entities, each entity of the set having an association with at least one other entity of the set; and a set of resources and/or rights possessed or controlled by each entity. A first entity of the set of entities determines the subset of resources and/or rights owned by the first entity that another entity may use, exercise or view details of, as appropriate, based on the minimum number of associations that exist between the first entity and the other entity. Other entities that otherwise meet the minimum number of associations may also be excluded from using, exercising or viewing details of the set of resources and/or rights by the first entity if recorded on an exclusion list.

### FIELD OF THE INVENTION

The present invention relates to a system and method for managing resources and rights. The invention is particularly adapted to manage the sharing of resources such as, for example, compact discs, videotapes and books or in the case of business/government organizations, large industrial equipment and spares via the internet by making use of their idle capacity, that is its availability as a function of time and for managing file-sharing in a computer network.

### BACKGROUND ART

The following discussion of the background to the invention is intended to facilitate an understanding of the present invention. However, it should be appreciated that the discussion is not an acknowledgement or admission that any of the material referred to was published, known or part of the common general knowledge in any jurisdiction as at the priority date of the application.

Many personal resources, such as compact discs, are under-utilised. One method of increasing the utilisation of such resources is to enter into sharing arrangements with others. However, this may involve substantial risk of loss or damage to the resource when the other members of the sharing arrangement are not known to the resource owner.

It is an object of one aspect of the present invention to instigate a system whereby a resource owner may increase the utilisation of personal and/or corporate/government resources by allowing such resources to potentially be used by other entities with whom the owner has an association.

The system is also able to be adapted for use in respect of rights available to the resource owner. For example, the system may be adapted to a file-sharing, e-mail arrangement (i.e. the right to view or modify an e-mail or the right to send an e-mail to a person and not have it treated as spam) or internet/instant messaging system.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is provided a system for managing resources and/or rights comprising:
a set of entities, each entity of the set having an association with at least one other entity of the set; and
a set of resources and/or rights possessed or controlled by each entity,
   wherein a first entity of the set of entities determines the subset of resources and/or rights possessed by the first entity that another entity may use or view details of, based on the minimum number of associations that exist between the first entity and the other entity.

In this respect the minimum number of associations is in essence a reference to the number of associations in the traversal path.

Preferably, each resource or right in the set of resources and/or rights is allocated an association level, such that entities having a minimum number of associations that exist between the first entity and the other entity in excess of the association level can not use or view details of that resource or right. More preferably, the association level can be set to a value representing that the corresponding resource or right is a private resource or right such that other entities in the set of entities are unable to use or view details of that resource or right.

Ideally, the association level has a value representing that, for the other entity to be able to use or view the resources and/or rights of the first entity, the number of associations that exist between the first entity and the other entity should not typically exceed 3. However the system of the present invention may employ a lesser or greater number of associations. The number of associations is selected dependent upon the particular use to which the system of the present invention is put.

Preferably, each entity in the set of entities has an exclusion list, such that entities included on the exclusion list are not able to use or view the resources and/or rights of that entity irrespective of the number of associations that exist between that entity and the other entity. Further, it may be provided that each entity is not able to use or view the resources and/or rights of each entity included on their respective exclusion list irrespective of the number of associations that exist between that entity and the other entity.

Preferably, each association has a weighting value, and the other entity may use or view resources and/or rights of the first entity having an association level greater than or equal to the minimum sum of weighting values of the number of associations that exist between the first entity and the other entity.

Preferably, each resource or right in the set or resources and/or rights has at least two association levels, and each association has at least two weighting values, the other entity may use resources and/or rights of the first entity having a first association level greater than or equal to the minimum number of associations that exist between the first entity and the other entity and where the other entity may view resources and/or rights of the first entity having a second association level greater than or equal to the minimum number of associations that exist between the first entity and the other entity.

Preferably, each association has at least two weighting values, and where the other entity may use or view resources and/or rights of the first entity having an association level greater than or equal to the minimum sum of first weighting values of the number of associations that exist between the first entity and the other entity and the first entity may use or view resources and/or rights of the other entity having an association level greater than or equal to the minimum sum of second weighting values of the number of associations that exist between the other entity and the first entity.

Preferably, each resource or right in the set of resources and/or rights has at least two association levels and where each association has to least two weighting values, the other entity may use resources and/or rights of the first entity having a first association level greater than or equal to the minimum sum of third weighting values of the number of associations that exist between the first entity and the other entity and where the other entity may view resources and/or rights of the first entity having a second association level greater than or equal to the minimum sum of fourth weighting values of the number of associations that exist between the first entity and the other entity.

Preferably, if there is a direct association between the first entity and the other entity, the minimum sum of weighting values between the first entity and the other entity is equal to the weighting value allocated to the direct association.

Preferably, a first entity may exclude another entity from using or viewing its resources and/or rights by creating a direct relationship between the first entity and the other entity having a weighting value in excess of the maximum sum of weighting values the system traverses in determining the set of resources and/or rights that the other entity may use or view.

Alternatively, a first entity may exclude another entity from using or viewing its resources and/or rights, where, on excluding the other entity, all other entities having an association with the first entity solely via the excluded other entity are also excluded from using or viewing the first entity's resources and/or rights.

In accordance with a second aspect of the present invention there is a user interface for a system of managing resources and/or rights according the first aspect of the invention, the user interface including:
means for displaying the resources and/or rights that a user can view or use; and
means for recording a request by the user to use a displayed resource or right.

Preferably, the user interface includes asset recording means to add a resource and/or right to the system, the asset recording means operable to receive a predetermined set of information and, using at least a portion of the predetermined set of information, reference a resource list to obtain a set of assets which substantially correspond to the portion of the predetermined set of information, the user thereafter able to choose the resource and/or right from the set of assets.

Ideally, the asset recording means operates to record a set of additional information in respect of each resource and/or right, a subset of the additional information not able to be viewed by other entities.

Preferably, the asset recording means includes a reader, the reader operable to read a unique identifier of a resource and referencing the unique identifier against a unique identifier database, obtain a predetermined set of details in respect of the resource.

Preferably, the asset recording means is a point of sale terminal incorporating a card reader, the card reader operable to read an identification card of a user and, with reference to identification information included on the identification card, record details of all resources and/or rights purchased with the system as resources and/or rights of the user.

Preferably, each resource includes condition information, including but not limited to date of purchase, vendor, value, initial warranty period, serial number, location.

More preferably, the user interface includes a calendar, the calendar operable to display information as to the availability of a selected resource or right. In particular, the calendar may be operable to display information as to the date, time and duration that a selected resource or right is available, or unavailable, to be used.

Preferably, the user interface is operable to send a series of reminders to an entity using a resource and/or right of the user following expiry of a loan period set by the entity and approved by the user, the series of reminders to continue until such time as the user records the resource and/or right as having been returned.

Preferably, the user interface comprises means for processing a request, confirmation and return by the user for the use of a displayed resource or right for a loan period.

Preferably, the user interface includes transfer means for transferring a resource and/or right between the user and an entity, the transfer means further operable to transfer any requests to use the resource and/or right along with the resource and/or right.

The user interface may also include invitation means for a first entity to invite a second entity to join the system, where, upon the second entity joining the system, a direct relationship is established between the first entity and the second entity.

Preferably, the invitation means checks to see whether the second entity has been invited to join the system more than a predetermined number of times within a predetermined time period and, if so, does not send an invitation to the second entity to join the system.

Preferably, the user interface includes summarising means for displaying at least one of the following: the number of resources and/or rights presently loaned to the user; the number of resources and/or rights presently loaned by the user; the number of resources and/or rights possessed by the user; the number of resources and/or rights possessed by the user by location.

More preferably, the information displayed by the summarising means is further restricted to those resources and/or rights that fall within a category chosen by the user.

Preferably, the user may send a recommendation message to at least one other entity.

Ideally, the user interface includes a personal website of the user, the user interface further operable to display the personal website to other entities of the system.

In accordance with a third aspect of the present invention there is a storage medium for software for implementing a system for managing resources and/or rights according to the first aspect of the present invention.

In accordance with a fourth aspect of the present invention there is a storage medium for software for implementing a user interface according to the second aspect of the present invention.

In accordance with a fifth aspect of the present invention there is a data processing apparatus having software for implementing a system for managing resources and/or rights according to the first aspect of the present invention stored in a memory thereof.

In accordance with a sixth aspect of the present invention there is a data processing apparatus having software for implementing a user interface according to the second aspect of the present invention stored in a memory thereof.

The data processing apparatus of the fifth and sixth aspects of the present invention may be a personal digital assistant or wireless application protocol enabled device or other digitally enabled device connected via a public network.

In accordance with a seventh aspect of the present invention there is a method of managing resources and/or rights comprising the step of determining the subset of resources and/or rights of the set of resources and/or rights possessed by a first entity that another entity may use or view based on the minimum number of associations that exist between the first entity and the other entity.

Preferably, the method includes the step of allocating an association level to each resource or right in the set of resources and/or rights; and where the step of determining the subset of resources and/or rights that another entity may use or view includes only those resources and/or rights that have an association level equal to or higher than the minimum number of associations between the first entity and the other entity.

### BRIEF DESCRIPTION OF THE DRAWINGS

An embodiment of the invention will now be described, by way of example only, with reference to the accompanying drawings, of which:

FIGS. 1a through 1e show a first embodiment of a set of database rules and structures of a system for managing resources and/or rights.

FIGS. 2a through 2c show a second embodiment of a set of database rules and structures of a system for managing resources and/or rights.

FIG. 3 is a representation of a registration screen for a user interface of a system for managing resources and/or rights.

FIG. 4 is a first representation of a network screen for the user interface of a system for managing resources and/or rights.

FIG. 5 is a second representation of a network screen for the user interface of a system for managing resources and/or rights.

FIG. 6 is a third representation of a network screen for the user interface of a system for managing resources and/or rights.

FIG. 7 is a representation of a summary page for the user interface of a system for managing resources and/or rights.

FIG. 8 is a first representation of a new asset screen for the user interface of a system for managing resources and/or rights.

FIG. 9 is a second representation of a new asset screen for the user interface of a system for managing resources and/or rights.

FIG. 10 is a representation of an asset list screen for the user interface of a system for managing resources and/or rights.

FIG. 11 is a representation of an additional information screen for the user interface of a system for managing resources and/or rights.

FIG. 12 is a first representation of a “My Friends” screen for the user interface of a system for managing resources and/or rights.

FIG. 13 is a second representation of a “My Friends” screen for the user interface of a system for managing resources and/or rights.

FIG. 14 is a representation of a locations screen for the user interface of a system for managing resources and/or rights.

FIG. 15 is a representation of a loans screen for the user interface of a system for managing resources and/or rights.

FIG. 16 is a representation of an assets screen for the user interface of a system for managing resources and/or rights.

FIG. 17 is a representation of an external loan screen for the user interface of a system for managing resources and/or rights.

FIG. 18 is a first representation of a buyer's guide screen for the user interface of a system for managing resources and/or rights.

FIG. 19 is a second representation of a buyer's guide screen for the user interface of a system for managing resources and/or rights.

FIG. 20 is a representation of a recommendation screen for the user interface of a system for managing resources and/or rights.

### BEST MODE(S) FOR CARRYING OUT THE INVENTION

In accordance with the present invention there is provided a system 10 for managing resources and/or rights. The system 10 is best described as two separate parts, the parts being as follows:
an application layer (described in more detail in the contextual example to follow); and
a set of database rules and structures.

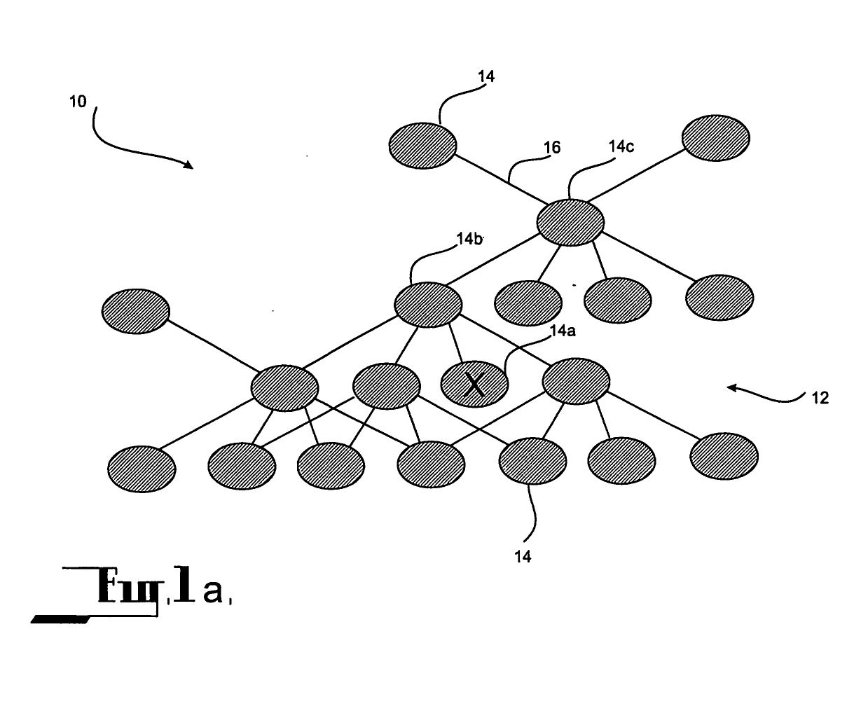

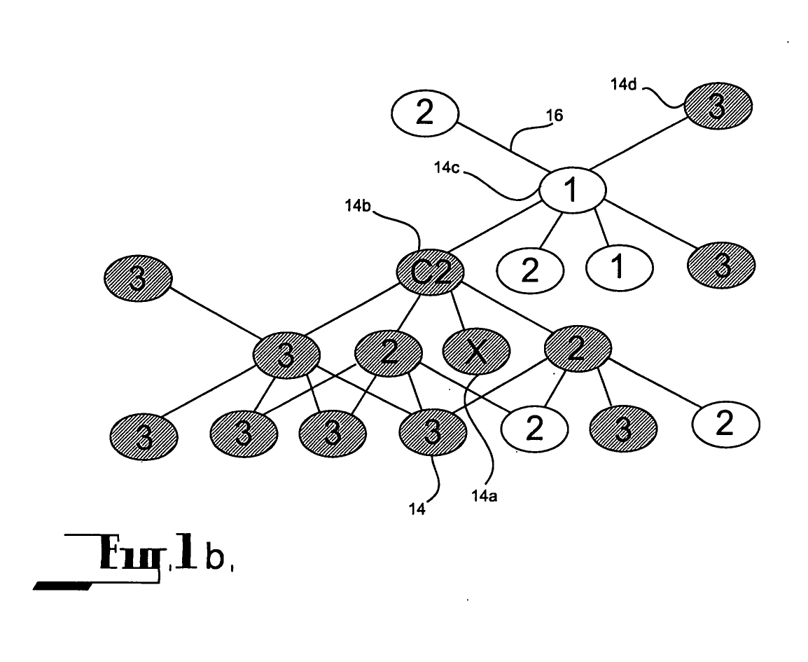

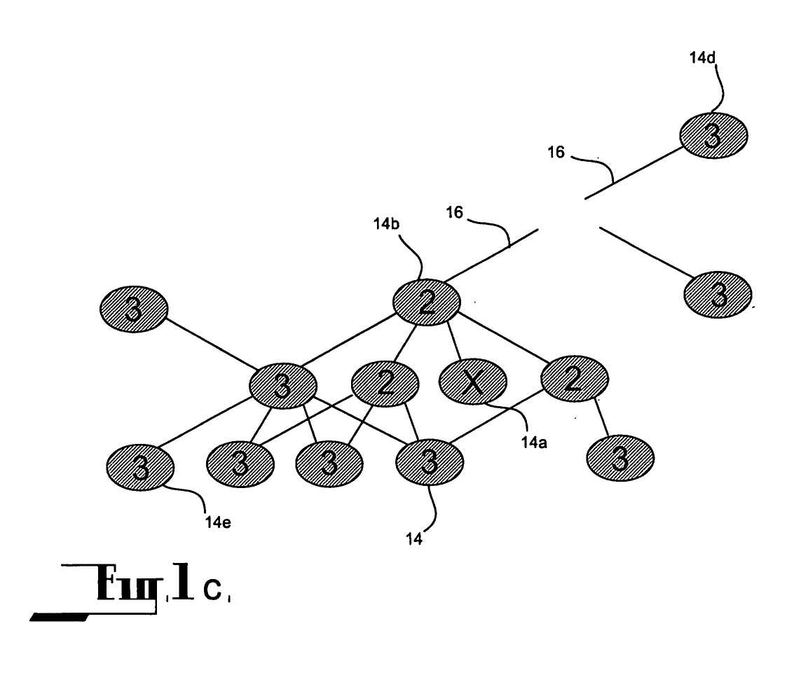

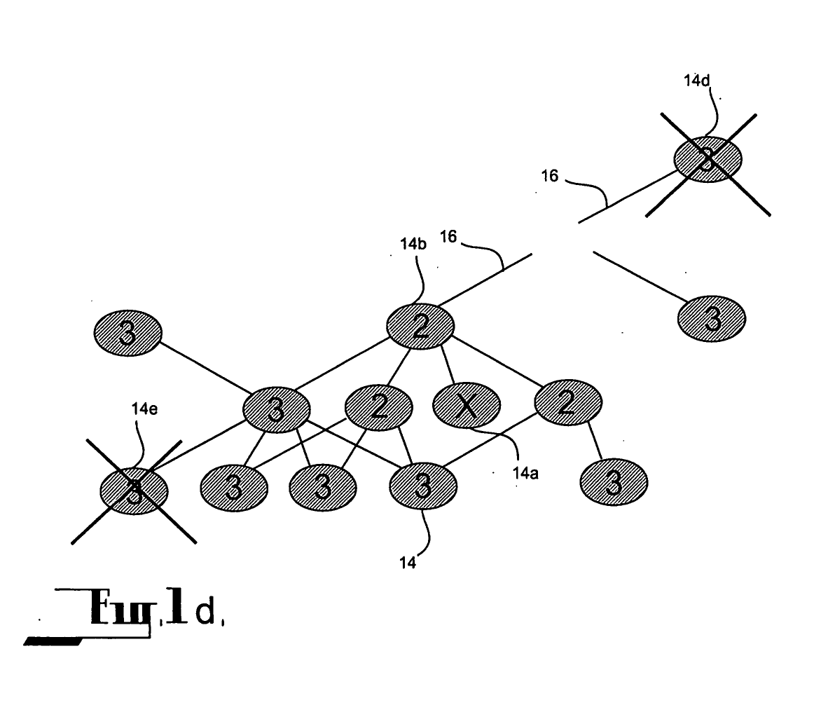

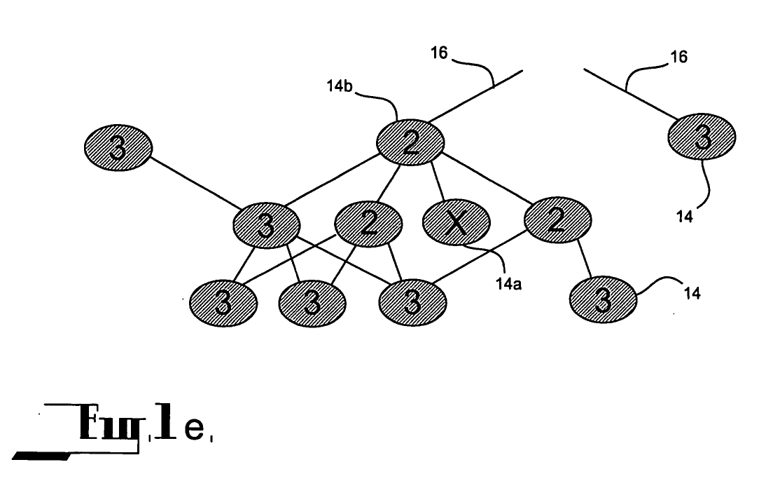

In accordance with a first embodiment of a set of database rules and structures 12 there is, conceptually, a set of nodes 14 and links 16. The set of nodes 14 and links 16 are arranged to form a mathematical graph (see FIGS. 1a through 1e).

Each node 14 in the set of nodes 14 represents a user of the system 10. A set of prescribed data, including data relating to resources and/or rights owned or possessed by the user, are stored as part of a record associated with the node 14 representing the user. The actual data recorded is described in more detail below.

Links 16 between nodes 14 represent associations. Links 16 from a first node 14a to a second node 14b are referred to as direct associations in relation to first node 14a and second node 14b. Adding a further link 16 from second node 14b to a third node 14c results in this link 16 being a direct association in respect of second node 14b and an indirect association in respect of first node 14a.

As mentioned above the system 10 implements a number of rules. These rules govern what resources and/or rights each user, as represented by a node 14, may view and/or loan from another user, as represented by a further node 14. For each set of data representing a resource or right entered into the system 10, the owner of the resource or right must set an association level. The association levels are shown in the ovals representing the nodes 14 in FIGS. 1a to 1e. The association level determines the maximum number of links 16 between nodes 14 that the system 10 can traverse when displaying the resources and/or rights that another user, as represented by their own node 14, may view and/or loan.

To elaborate, in the example of nodes 14a, 14b, 14c described above, in respect of a resource of the user represented by node 14a:
setting an association level of 0 for the resource would mean that neither the user represented by node 14b or the user represented by node 14c may view or loan the resource. Thus, in essence, such a resource is a private resource;
setting an association level of 1 for the resource would mean that the user represented by node 14b is able to view or loan the resource, however, the user represented by node 14c is not able to view or loan the resource; and
setting an association level of 2 for the resource would mean that both the user represented by node 14b and the user represented by node 14c are able to view or loan the resource.

And so on as the system 10 grows to include additional nodes 14 and links 16.

Note that in this arrangement when determining resources and/or rights that one user may view and/or loan, intermediate association levels are disregarded. To illustrate further, in the above example, consider the following:
the user represented by node 14c forms a direct association with the user represented by new node 14d;
the user represented by node 14c sets an association level of 1 for all of its resources and rights; and
the user represented by node 14d sets an association level of 3 for all of its resource and rights.

Thus, while the user represented by node 14a is not able to view and/or loan the resources and/or rights of the user represented by node 14c (by virtue of such resources and/or rights having an association level of 1), it does not prevent the user represented by node 14a from being able to view and/or loan the resources and/or rights of the user represented by node 14d (the association level of such resources and/or rights being set to level 3).

For practical purposes, it is considered that users should not be able to set an association level for any resource or right beyond 3. If association levels beyond 3 are set, as the system 10 grows to include a sizeable number of nodes 14, substantial delays to the system 10 can occur. Further if no maximum is set, the system 10 may become unwieldily as a result of the system 10 using a program to gather, in a recursive fashion, details of all resources and/or rights, the program operable to traverse all possible links up to the maximum association level set for any one resource or right.

While the above represents an ideal system 10, there may be situations where the user, as represented by node 14a, does not wish for a user, represented by a node 14 with whom it has an indirect association, from being able to view and/or loan their resources and/or rights. To achieve this objective, the data correlated to each node 14 includes an exclusion list. Thus, when receiving a query from the program on behalf of another node 14 for details of resources and/or rights that the user represented by said node 14 may view and/or loan, if the other node 14 meets the association level criteria set for a resource or right, a check is also made of the exclusion list to confirm that the user represented by the other node 14 retains the right to view and/or loan the resource or right, as appropriate. If so, details of the resources and/or rights that can be viewed and/or loaned are provided to the program.

It should be noted that inclusion of a node 14 on an exclusion list by another node 14a, has no effect on node's 14a ability to view the resources and/or rights of that node 14 or any other node 14 having an indirect association with node 14a via the excluded node. For example in FIG. 1d nodes 14d and 14e have been included in the exclusion list of node 14a and hence they can not view the resources and/or rights of 14a but node 14a can view the resources and/or rights of nodes 14d and 14e. This can be changed. For example, exclusion may be a two-way mechanism, in which case node 14a would not be able to view the resources and/or rights of the excluded node 14. For example in FIG. 1e the two-way exclusion mechanism works such that additionally node 14a can not view the resources and/or rights of nodes 14d and 14e.

In the system 10, as previously hereinbefore described, the relationships that the user, represented by the node 14a, has with other users, represented by the other nodes 14, has been from the perspective of the node 14a. In the system of the present invention, it is preferable that the other nodes 14 with which the node 14a has a relationship are able to have a different level of relationship with the node 14a. Thus, each node 14 is able to have its own respective relationship with any other node 14 in the system. By way of example, if a first node 14 was not able to view or use resources or rights of a second node 14, that would not necessarily mean that the second node 14 is unable to view or use resources or rights of the first node 14. The system does, however, also allow the alternative situation, i.e. the situation in which the relationships between two nodes are the same as regards the resources and rights of a first node that may be viewed and used by the second node.

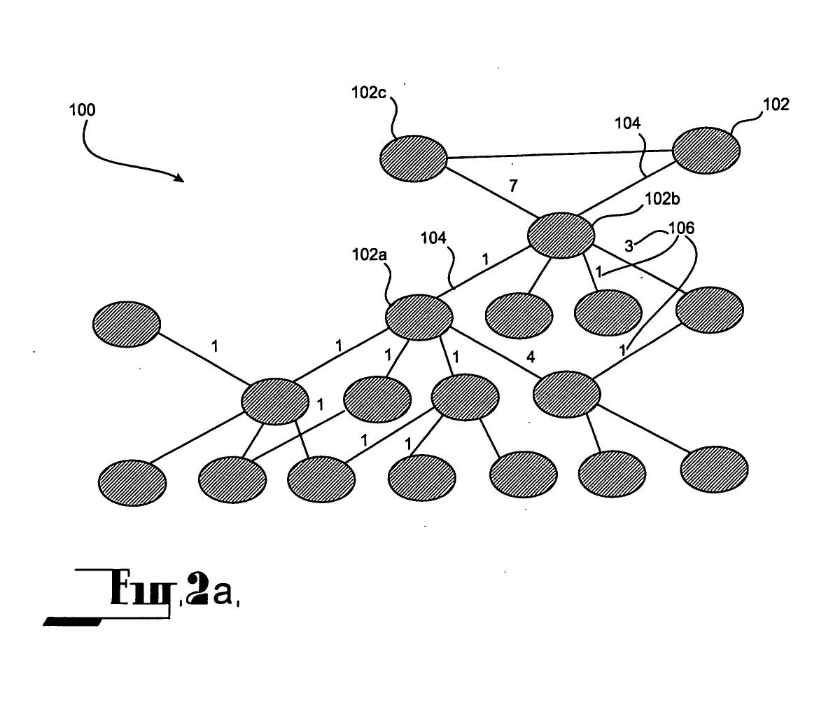

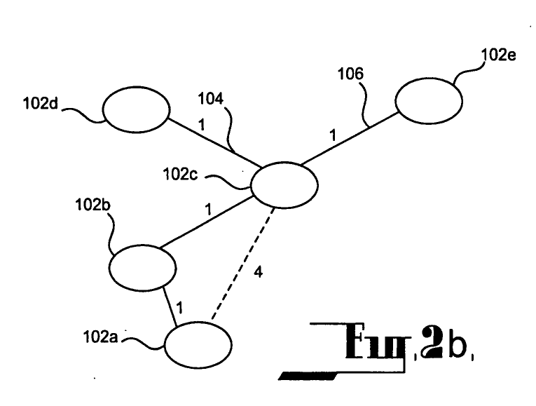

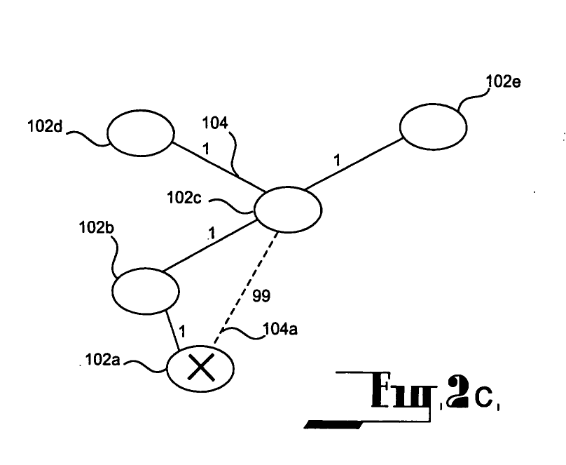

In accordance with a second embodiment of a set of database rules and structures 100, there is, conceptually, a set of nodes 102 and links 104. The set of nodes 102 and links 104 are arranged to form a mathematical graph (see FIGS. 2a through 2c).

Each node 102 in the set of nodes 102 represents a user of the system 10. A set of prescribed data, including data relating to resources and/or rights owned or possessed by the user, are stored as part of a record associated with the node 102 representing the user. As before, the actual data recorded is described in more detail below.

Links 104 between nodes 102 represent associations. Links 104 from a first node 102a to a second node 102b are referred to as direct associations in relation to first node 102a and second node 102b. Adding a further link 104 from second node 102b to a third node 102c results in the link 104 being a direct association in respect of second node 102b and an indirect association in respect of first node 102a. Each link 104 also has a weighting value 106.

For each set of data representing a resource or right entered into the system 10, the owner of the resource or right must set an association level. The association level determines the maximum sum of weighting values 106 of links 104 between nodes 102 that the system 10 can traverse when obtaining details of the resources and/or rights that another user, as represented by their own node 102, may view and/or loan.
To elaborate, with particular reference to FIG. 2a, in the example of nodes 102a, 102b, 102c described above, assuming that the association between node 102a and node 102b has a weighting value of 1 and the association between node 102b and node 102c has a weighting value of 7, then in respect of a resource of the user represented by node 102a:
setting an association level of 0 for the resource would mean that neither the user represented by node 102b or the user represented by node 102c may view or loan the resource. Again, this represents a private resource;
setting an association level between 1 and 7 for the resource would mean that the user represented by node 102b is able to view or loan the resource, however, the user represented by node 102c is not able to view or loan the resource; and
setting an association level of 8 or more for the resource would mean that both the user represented by node 102b and the user represented by node 102c are able to view or loan the resource.

Similarly, as in the first embodiment of database rules and structures 12, when determining resources and/or rights that one user may view and/or loan, intermediate association levels are disregarded.

Again, for practical purposes, it is considered that users should not be able to set an association level for any resource or right beyond 3.

A preferred aspect of the second embodiment of a set of database rules and structures 100 is that weighting values 106 associated with a direct relationship take precedence over weighting values 106 representative of an indirect relationship. Accordingly and with particular reference to FIG. 2b, consider the following set of nodes 102 and links 104 (for simplicity each link 104 has a weighting value 106 of 1):
node 102a has a direct association with node 102b;
node 102b has a direct association with nodes 102a and 102c;
node 102c has a direct association with nodes 102b and node 102d and node 102e;
node 102d has a direct association with node 102c; and
node 102e has a direct association with node 102c.

Node 102c has summed weighting value of 2 by way of its indirect relationship with node 102a via node 102b, if node 102a were to create a direct relationship with node 102c having a weighting value 106 of 4, the direct relationship weighting value 106 takes precedence and thus the user represented by node 102c can view and/or loan any resource or right of the user represented by node 102a having an association level of 4 or more. Nodes 102d and 102e have an indirect association through nodes 102b and 102c of 3 and therefore can see any resource or right of the user represented by node 102a having an association level of 3 or more. It however is further envisaged as an alternative that indirect associations be created in such a way as to preserve the direct links of other nodes 102. In which case nodes 102d and 102e, linked only through node 102c, must use the direct association between nodes 102a and 102c and therefore can see any resource or right of the user represented by node 102a having an association level of 5 or more.

The above represents an ideal system 10. Similarly, exclusion of nodes can be made to operate in the same manner as direct associations that over-ride indirect associations. This is done by placing a weighting value 106 on the new direct association that is higher than the maximum sum of weighting values that the system can traverse (notionally 99). This arrangement is exemplified in FIG. 2c.

Furthermore, where a first node 102c is excluded from a second node 102a in the manner herein described, any nodes 102 (for example nodes 102d and 102e) that can be associated with 102a only via node 102c, either directly or indirectly, associated can be excluded; or alternatively not excluded.

In the most preferred arrangement of this embodiment, and in respect of the database rules and structures 100 that underlie the contextual example set out below, each link 104 has a first weighting value 106a and a second weighting value 106b. The first weighting value 106a represents the weighting value 106 given to the link 104 by the node 102 who initiated the link 104. The second weighting value 106b represents the weighting value 106 given to the link 104 by the node 102 who did not initiate the link 104. In this manner, the exclusion of one node 102 can be a one-sided matter—the excluded node 102 may still allow the user representing the node 102 that excluded it to view and/or loan its associated resources and/or rights.

As an optional arrangement to either embodiment of database rules and structures 12, 100, it is envisaged the user of each resource and/or right, as represented by a node 14, 102 may be required to set two association levels. The third association level sets the association level that determines which other users, as represented by their respective nodes 14, 102, may view the resource or right, as appropriate. The fourth association level sets the association level that determines which other users, as represented by their respective nodes 14, 102, may loan or use the resource or right as appropriate.

The system 10 will now be described by way of example, where the system 10 is commercial in nature. However, it should be appreciated that:
the system 10 described is an application built around the second embodiment of the set of database rules and structures 100, including the dual weighting value 106 arrangement, described above, although the system 10 as described could easily be modified by the person skilled in the art to implement the first embodiment of the database rules and structures described above.
the same system 10 can be implemented such that use of the system 10 is personal in nature.

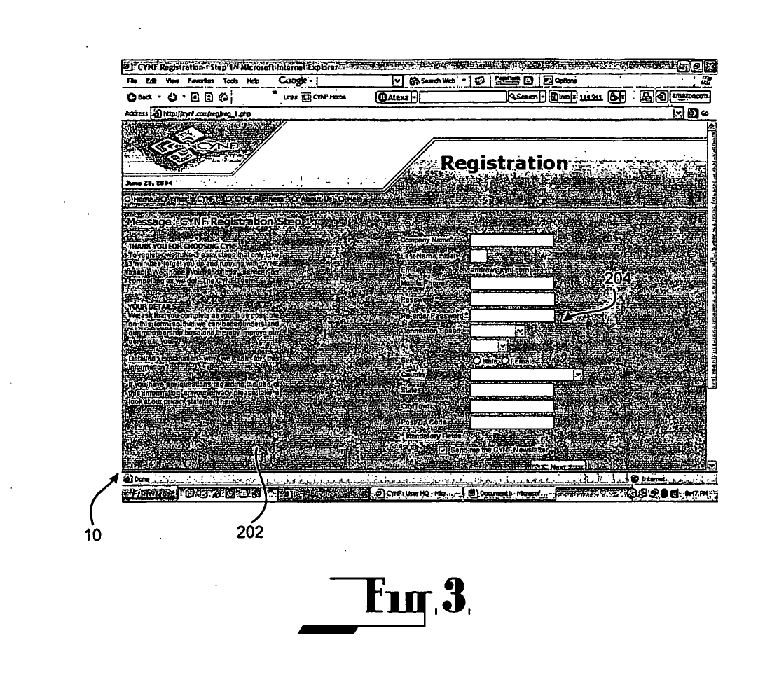

A company 200 accesses the system 10. Being a new user of the system 10, and not having been invited to join the system 10 by another user, the company 200 is shown registration page 202 (see FIG. 3).

Registration page 202 requests the company 200 to enter in a series of corporate details in the respective fields 204. The Corporate Name and Password fields are mandatory.

All other fields 204 are optional. Once the company 200 has entered in at least a portion of the requested corporate details, the portion including the mandatory fields, and indicated acceptance of those details, the registration page 202 is replaced with network page 206.

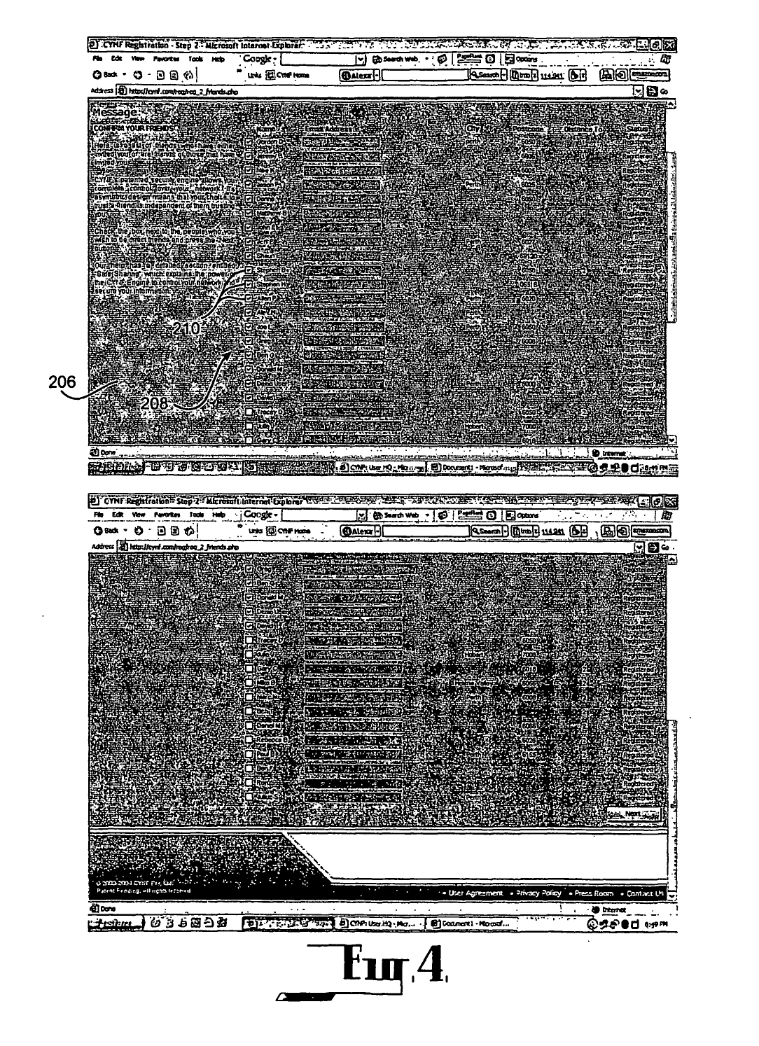

Network page 206 first performs a check of existing associations in the system's database. This check involves searching for direct associations formed by other users who are existing members of the system 10 that include company 200. Not being a previous user of the system 10, such direct associations will represent the company 200 as the party having use or viewing rights in respect of the resources of the users who created the direct association. The network page 206, as shown in FIG. 4, then displays details 208 of each company (the example shown uses individual names for company names) that created each direct association identified by the check. The details 208 are each associated with a checkbox 210.

The company 200 is then able to select one or more users with whom it wants to reciprocate the direct associations, by way of checking each checkbox 210 associated with the details of the users concerned.

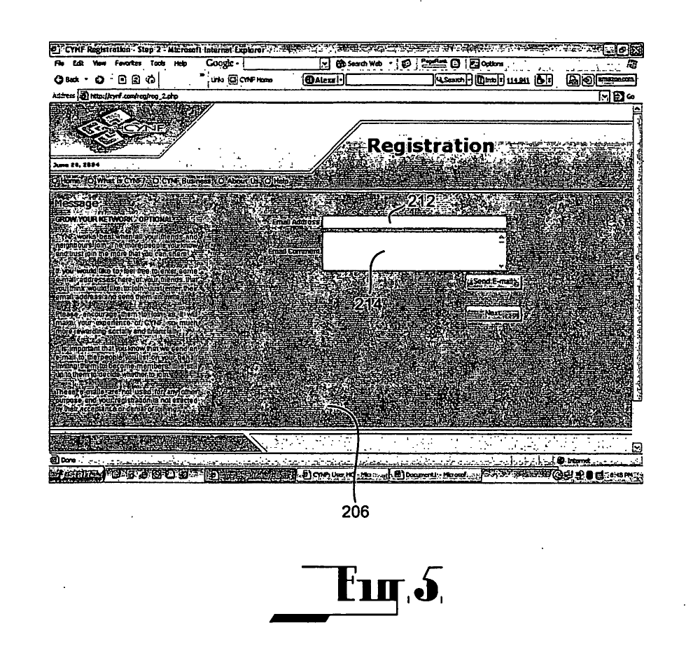

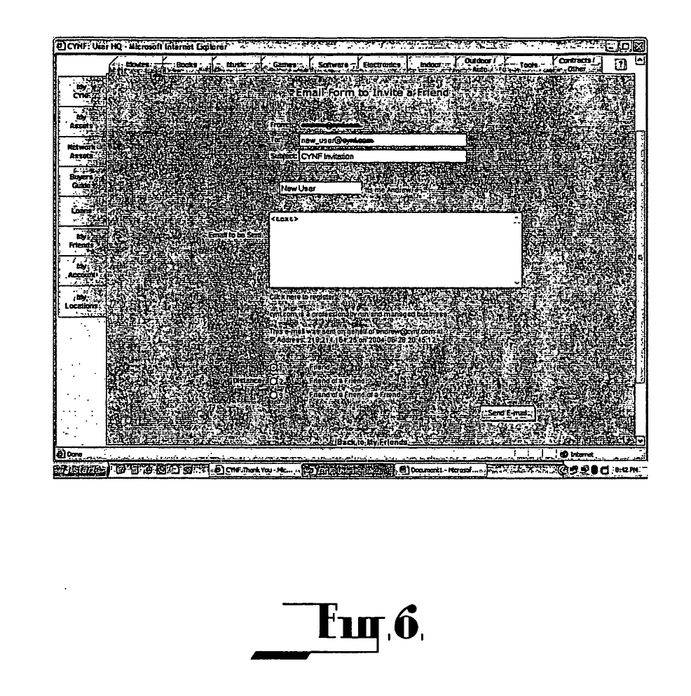

If no direct association has been formed involving company 200, or on completion of the actions referred to in the last two paragraphs, network page 206 operates to display a data entry field 212 and a display list 214 (see FIG. 5). Through data entry field 212 the company 200 is prompted to enter e-mail addresses of associated users that they feel would benefit from inclusion in the system 10. As the data entry field 212 can only handle one e-mail address at a time, previously entered e-mail addresses are displayed within display list 214. In this manner, the company 200 can check that it is not about to enter in a duplicate e-mail address. Once the e-mail addresses of all associated users of interest have been entered by the company 200, the network page 206 checks whether each e-mail address entered corresponds with an e-mail address of an existing user of the system 10. Where an e-mail address corresponds with an e-mail address of an existing user of the system 10, the network page 206 operates to create a direct association with that user. Where an e-mail address does not correspond with an e-mail address of an existing user of the system 10, an invitation e-mail is sent to the e-mail address specified. An invitation e-mail can also be sent at any time by the company 200 by clicking on invite a friend button 216 (see FIG. 6). In both cases, the invitation e-mail provides a link through which the associated company can register themselves as a user of the system 10. The registration process via the link provided in the invitation e-mail is identical to that already described in respect of company 200.

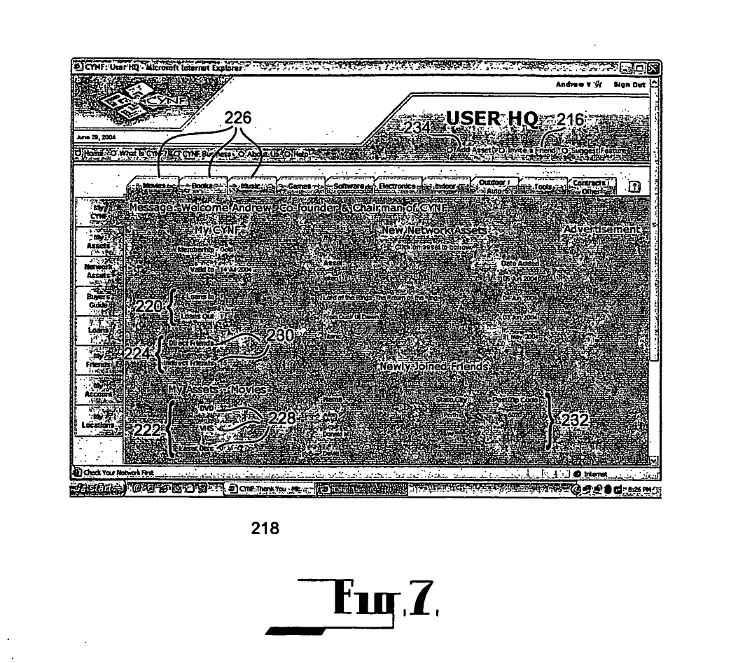

The company 200 is then shown summary page 218 (see FIG. 7). Summary page 218 displays the following information to the company 200:
a loan summary 220;
a resources summary 222; and
a system summary 224.

With the exception of the system summary 224, the information displayed on summary page 218 is determined by a category type. The various category types are displayed as tabs 226.

Loan summary 220 details the total number of loans of resources of the selected category type made available by the company 200 to other users of the system 10. Loan summary 220 also details the total number of loans of resources of the selected category type made available by other users of the system 10 to the company 200.

Resources summary 222 comprises a number of data fields 228. Each data field 228 represents a sub-category of the selected category type. The data fields 228 detail the total number of resources recorded for the company 200 that fall into the sub-category of the category type the data field represents.

System summary 224 comprises numerical summary 230 and user summary 232. Numerical summary 230 displays the total numbers of direct and indirect associations, respectively, formed with company 200. User summary 232 displays limited details of any new direct associations formed by other users with company 200.

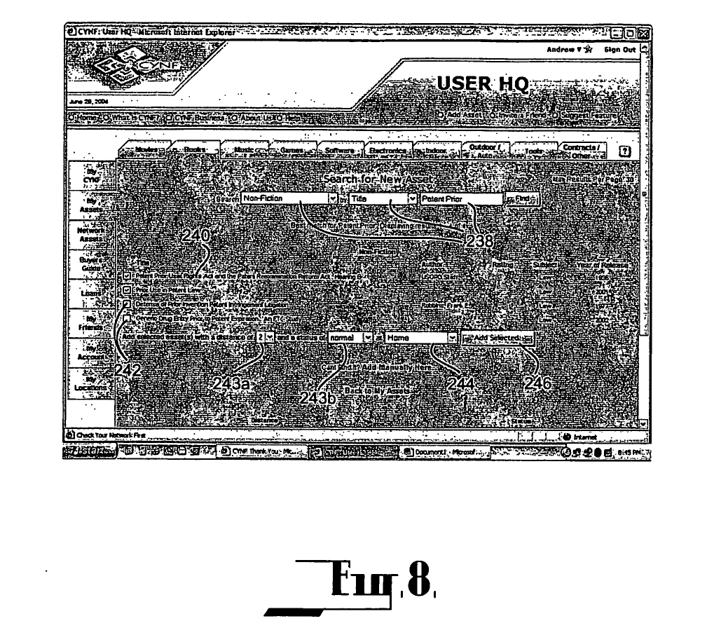

The company 200 then proceeds to add resources to the system 10. To do so, they must first click on add asset button 234. On clicking add asset button 234, new asset screen 236 is displayed (see FIG. 8).

New asset screen 236 includes search fields 238. Search fields 238 allow the company 200 to specify the category, subcategory and keywords for the new resource. The category and subcategory choices are the same as those recorded for tabs 226 and the subcategories associated with data fields 228.

From the information included in the search fields 238, a search is made of resource lists stored in the database for matching resources. Matching resources are then displayed in a table format 240. Each matching resource displayed has an associated checkbox 242. The company 200 is able to choose one or more matching resource(s) that correspond with the intended new resource(s), by selecting the associated checkbox 242 for those matching resource(s).

On selecting one or more associated checkboxes 242, the company 200 can then select additional information relating to each new resource. This additional information includes:
an association value 243a to apply to the new resource;
a status 243b for the new resource; and
a location 244 for the new resource.

The association value represents the maximum association value that another user of the system 10 must have in order to use or view the new resource as determined by the database rules and structures described above.

The status of each new resource can be any of the following: “Normal”; “Invisible”; “Reserved”; “Sale/Swap”. Setting the status of the new resource to “Invisible” means that the new resource will not be able to be viewed by any other user, regardless of association value. Setting the status of the new resource to “Reserved” means that while other users will be able to view the new resource, the new resource is not available for use. The other status values are self-explanatory.

The location of the new resource can be chosen from a drop-down list. The locations recorded in the drop-down list are sourced from information entered via a locations page 244. The locations page 244 will be described in more detail below.

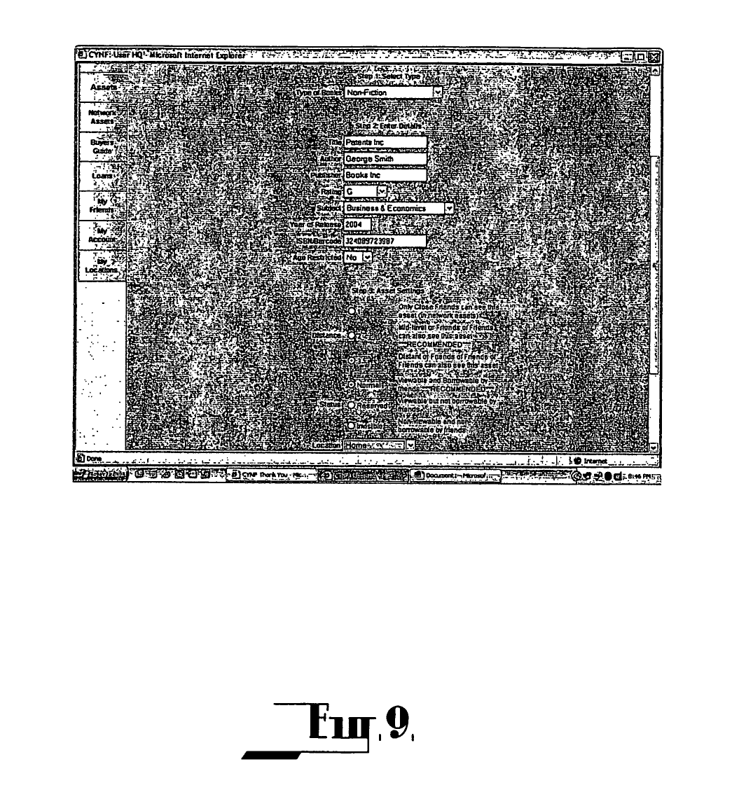

Once the company 200 has entered all details in respect of the new resource, push button 246 is pressed to commit the details to the database. Alternative, using the form displayed as FIG. 9, the company 200 may enter in details of each new resource without the assistance of the resource lists.

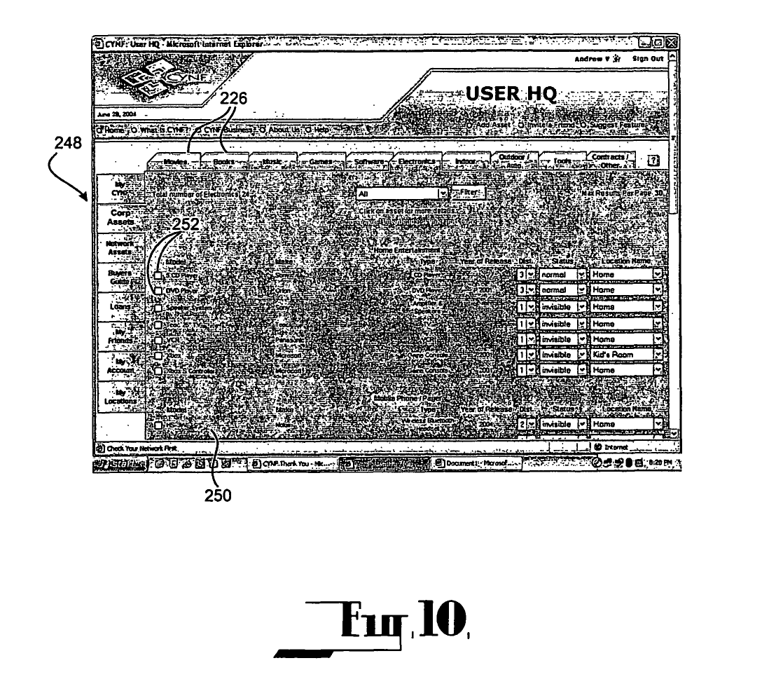

The company 200 is able to view details of all their resources by clicking on the side-tab 248 marked “Corp Assets” (see FIG. 10). On clicking side-tab 248, the resource inventory page 250 is displayed. Resource inventory page 250 comprises a list of all resources owned by the company 200 that fall within the selected category (as determined by tabs 226). The resources displayed are grouped according to the sub-categories for the category, as associated with data fields 228.

Each-resource displayed has a checkbox 252 associated therewith. By selecting the checkbox 252 of an associated resource and hitting push button on the page labelled “Delete” (not shown), the resource associated with the selected checkbox 252 is deleted.

The company 200 is also able to change the association value, status and location information of each resource displayed. This is achieved in the same manner as described above. Again, any such changes must comply with the database rules and structures described above.

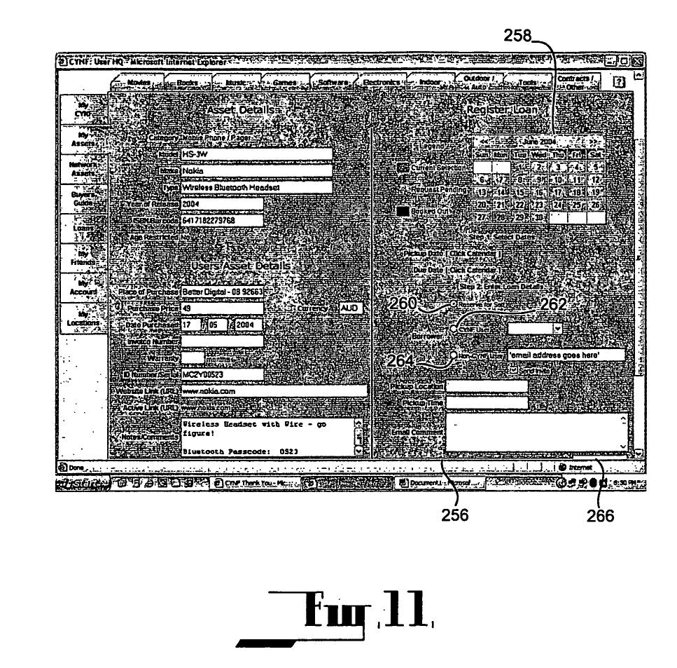

Additional details of a resource can be viewed by the company 200 by clicking on the resource name. This creates additional information page 256 (see FIG. 11). Additional information page 256 shows additional details in respect of the selected resource. Such additional details may include the place, amount paid and date of purchase as well as warranty related information. Some, or all of the information can be set such that it is not visible to other users. Additional information page 256 also includes a calendar 258. Dates specified in calendar 258 are colour coded. Dates coloured red represent dates when the associated resource is on loan or is reserved for use by the company 200. Dates coloured orange represent dates when another user of the system 10 has requested use of the associated resource, and that request has not yet been confirmed by the company 12. Dates coloured green represent the present selected dates. Agreed but this section is describing the operation of the system currently. A company 200 will select dates, thereafter coloured green on calendar 258, when seeking to reserve use of the associated resource for the company 200 or when another person (who may or may not be a user of the system 10) has sought use of the associated resource for the selected dates. In order for the system 10 to appropriately track use of the associated resource for the selected dates, the company 200 must:
select radio button 260 if it wishes to reserve the associated resource for its own use. In this case, a reservation entry is recorded to the database.
select radio button 262 if the associated resource is to be loaned to another user of the system 10 on the selected dates. In this situation, the company 200 must also specify the name of the other user of the system 10. A loan entry is then recorded to the database. It should be noted, however, that such a loan must still comply with the database rules and structures described above. Accordingly, it is not possible in the embodiment being described for a loan to be made to a party having an association with a weighting value in excess of the association value of the associated resource.
select radio button 264 if the associated resource is to be loaned to a person not being a user of the system 10 on the selected dates. In this situation, the company 200 must also enter in an e-mail address for the person, so that appropriate return reminders can be sent to him/her. An external loan entry is then recorded to the database.

In any case, the selected dates are subsequently colour-coded red upon acceptance (indicated by clicking on push-button 266). Further, on acceptance, the additional information page 256 operates to send an e-mail both to company 200 and to the person or user, as appropriate, confirming the loan with them.

Information regarding delivery of the associated resource to the user or person, as appropriate, may also be recorded on the additional information page 256 in the appropriate data field.

An identical process to the aforementioned loan process is followed when seeking to transfer the resource or right. The company 200 need only perhaps? As this is not written in stone, it might be an untimed transfer specify a single date on the calendar 258, being the date from which the transfer will be effective. On that date, the intended recipient of the resource or right will be sent an e-mail requesting them to confirm receipt of the resource or right. Confirmation of receipt of the resource or right is also to occur via e-mail. On receipt of the confirmation e-mail, the system 10 operates to transfer the possessive and/or control relationship between the resource or right from the company 200 to the intended recipient.

Any loans recorded in respect of the transferred resource or right are transferred along with the resource or right.

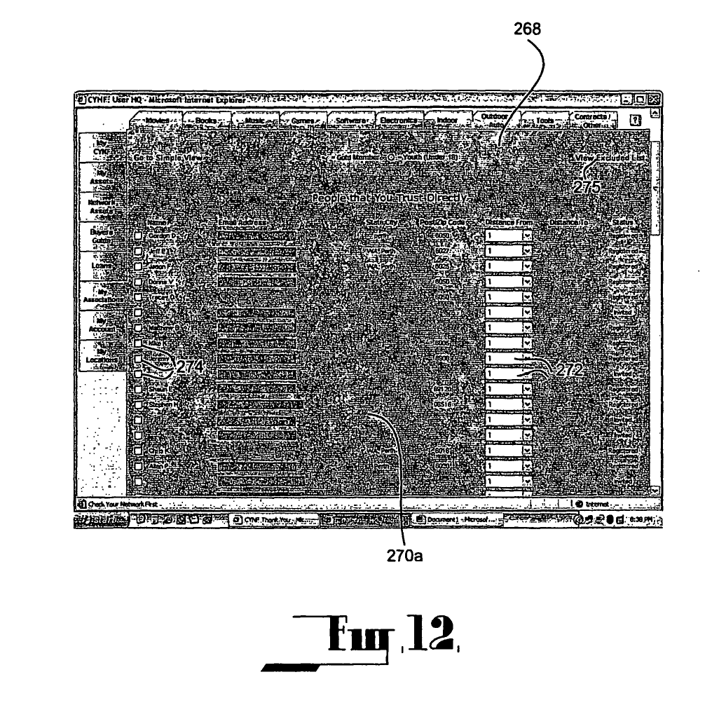

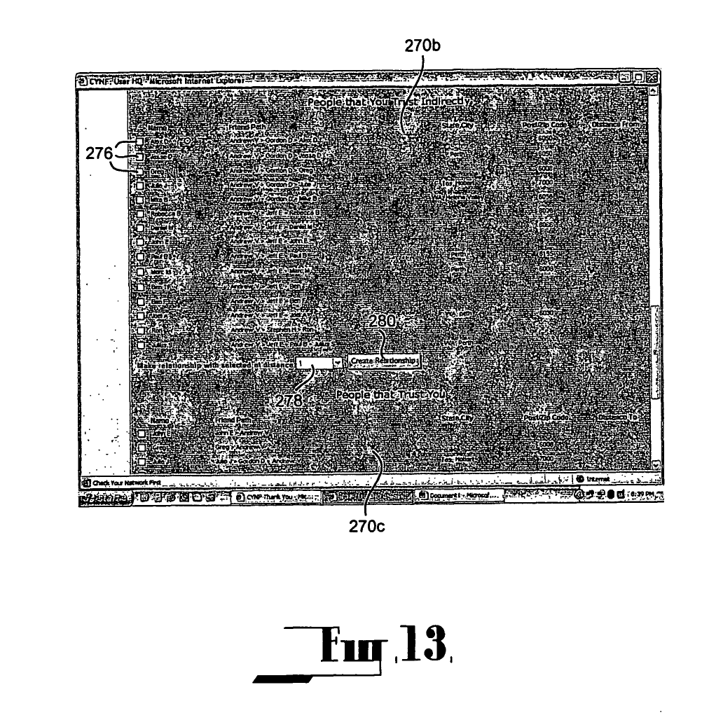

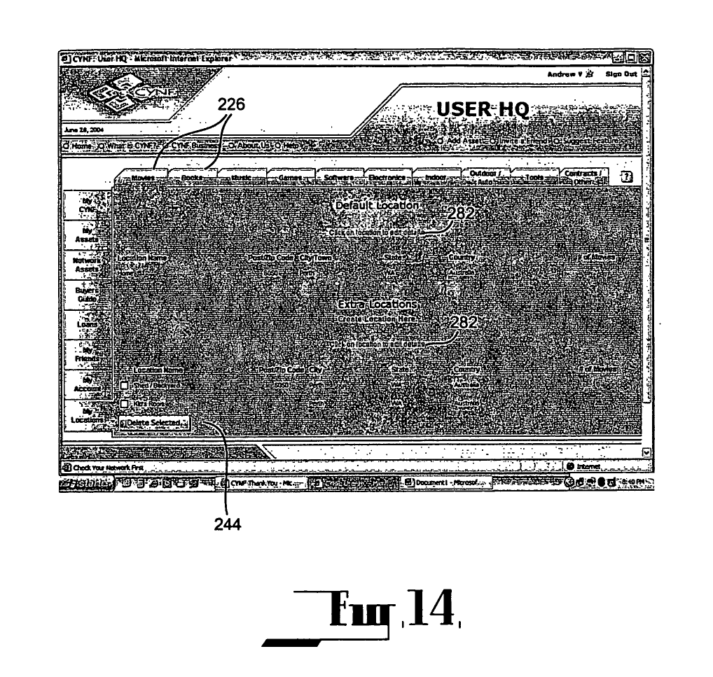

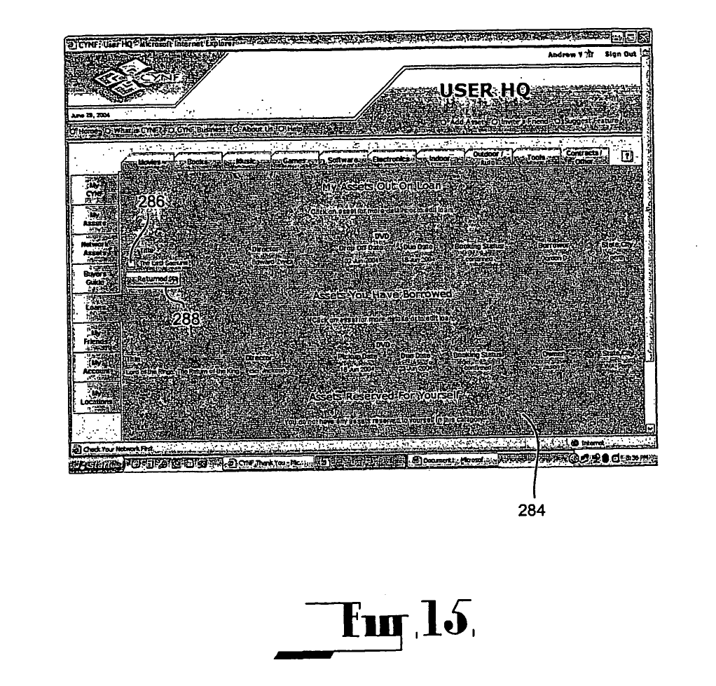

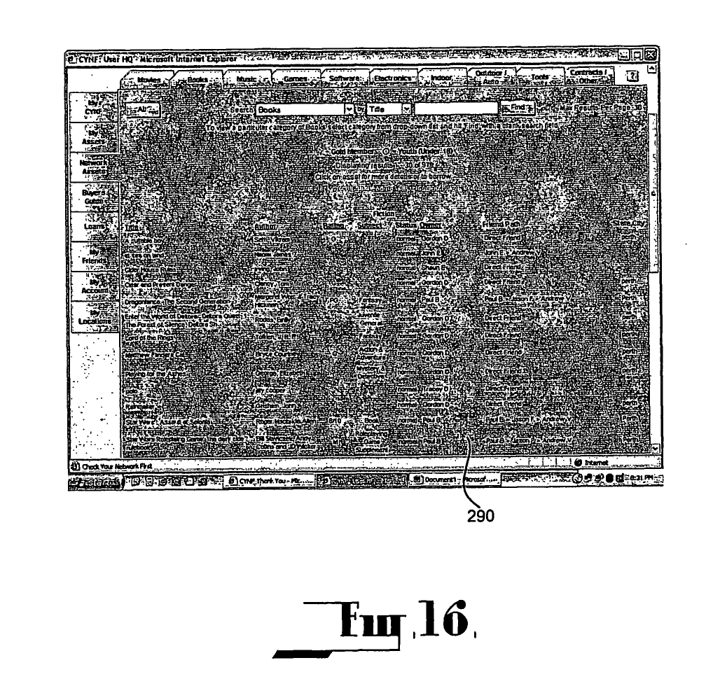

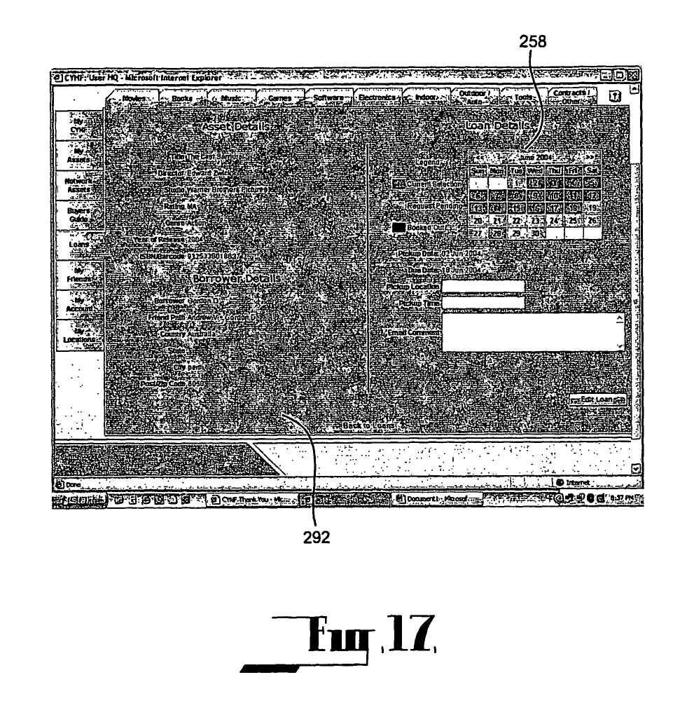

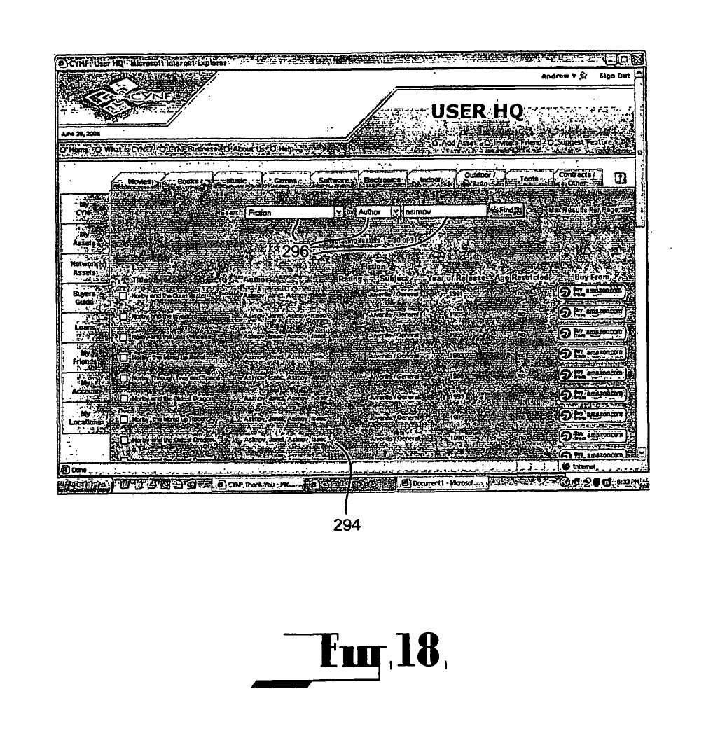

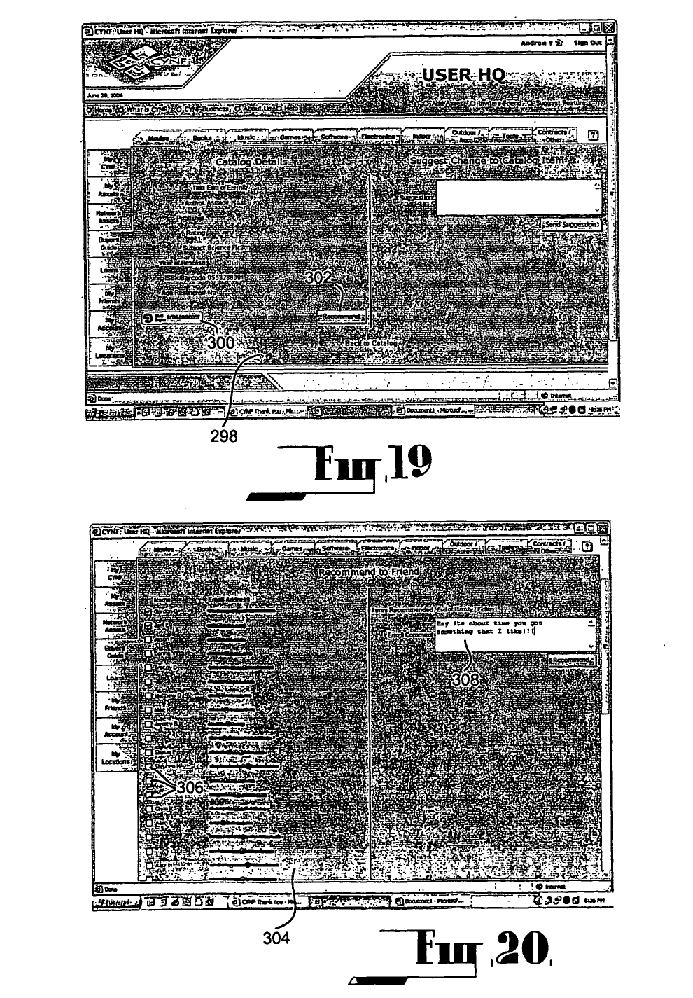

The company 200 may then check the direct associations and indirect associations it has with other users of the system 10 by accessing the associations page 268 via the “My Associations” should this tab be changed to ‘my colleagues’—I think currently on the corp site it is Corp Friends side tab 248. See FIGS. 12 and 13.

Associations page 268 is split into three categories 270a, 270b, 270c. Category 270a provides details of all other users with whom the company 200 has a direct association with. Category 270b provides details of all other users with whom the company 200 has an indirect association with. Category 270c provides details of all other users who have an indirect association with the company 200. In this manner, the two-way orientation of the system 10 is reflected in the differences in details provided in the various categories 270.

Category 270a provides the following details in respect of each user:
their name;
if the direct association with that user has a weighting value, as set by that user, of 1, their e-mail address;
their location (in a general sense);
the weighting value assigned by the company 200 to the direct association they have with the user;
the weighting value assigned by the user to the direct association, if any, they have with the company 200; and
their status.

Some of the above details are optional and therefore may be left blank. In the case of users having a status of “invited”, the name, location and weighting value assigned by the user to the direct association fields are left blank.

The weighting value assigned by the company 200 to the direct association they have with any user may be changed by means of a drop-down box 272. Thus, the company 200 can manage its associations in a simple manner.

Details of each user in category 270a have an associated checkbox 274. By selecting the checkbox 274 associated with a user, and pressing a deletion button (not shown), the company 200 can delete the link it has established with the associated user. Alternatively, if the user is only to be excluded, the user may select “excluded” from drop-down box 272. Exclusion results in the weighting value assigned to the direct association the company 200 has with that user to be set to a pre-specified exclusion value (in this example notionally 99). Details of the associated user are then omitted from those displayed in category 270a. Details of any excluded user are visible by means of the excluded list (accessible by hyperlink 275). If a user has been incorrectly excluded, the original association may be restored by appropriate operation of the excluded list.

Category 270b provides the following details in respect of each user:
their name;
details of the path of users through whom the indirect association is formed. If there are more than one path that the indirect association can take, details of the users through whom the indirect association having the lowest sum of weighting values is formed is displayed. Further if there are more than one path having that the indirect association can take, each having the same weighting value, the system 10 operates to display the first path identified.
their location (in a general sense); and
the sum of weighting values allocated to each association in the path;

Details of each user in category 270b have an associated checkbox 276. At the bottom of the list of details, is a weighting value drop-down list 278. By selecting one or more checkboxes 276 associated with users, choosing a weighting value from the weighting value drop-down list 278 and selecting the create relationships push button 280, the company can create direct associations with each user associated with a selected checkbox 276. Each direct association is allocated the weighting value chosen from the weighting value drop-down list 278. As the company 200 has now created a direct association with such users, their details are subsequently displayed as part of the list provided by category 270a.

By selecting the checkbox 276 associated with a user, and pressing a create relationship push button (not shown), the company 200 can exclude the associated user. Exclusion results in the weighting value assigned to the direct association the company 200 has with that user to be set to a pre-specified exclusion value (in this example notionally 99). Details of the associated user are then omitted from those displayed in category 270a. Details of any excluded user are visible by means of the excluded list (accessible by hyperlink 276). If a user has been incorrectly excluded, the original association may be restored by appropriate operation of the excluded list.

As mentioned above, category 270c provides details of other users who have an indirect association with the company 200. The details described in category 270c are the same as those described in respect of category 270b. The difference is that the path of users and weighting values applied to associations in the path of users is taken from the other user's point of view.

As mentioned above, the company 200 must, when adding a new resource or right, select a location from a drop-down list. The locations specified in the drop-down list are recorded via the locations page 244 accessible via the “My Locations” side tab 248.

Locations page 244 displays a default location and other locations associated with the company 200 where resources and/or rights may be kept. Through use of hyperlinks 282, a new location may be added or details of an existing location may be edited. A location, other than the default location, may be deleted by selecting the checkbox associated with the location to delete and pressing the “delete selected” push button.

Locations page 244 cross-references the categories represented by tabs 226. In this manner, when displaying details of each location associated with the company 200, the locations page 244 also specifies the number of resources and/or rights associated with the category represented by tabs 226 recorded as located at the location. This provides the company 200 with an overview of the position of their resources and/or rights by location. It also acts as a constraint, so as to ensure the integrity of the underlying database, it is not possible to delete a location having any resources and/or rights recorded against it—regardless of category.

A more complete description of items on loan than that provided by loan summary 220 can be obtained by clicking on the “loans” side tab 248 and accessing the loans page 284. Loans page 284 displays details, respectively, of resources and/or rights that the company has lent out, has received as a loan and has reserved for itself. In respect of resources and/or rights that have been lent out by the company 200, each resource or right has an associated checkbox 286. When the resource or right has been returned to the company 200, the company selects the checkbox associated 286 with the returned resource or right and presses the “returned” push button 288.

The loans page 284 plays an important part in the processing of loans. Each loan of a resource or right has an associated set of reminder dates. On each date in the set of reminder dates a reminder e-mail is issued to the user who lent the resource or right requesting its return to the company 200. The issue of reminder e-mails continues until the resource or right is returned. Upon return, the company 200 enters the loan page 284 and completes the process referred to above. This then operates to cancel the issue of further reminder e-mails on the dates specified in the set of reminder dates.

In respect of loans recorded for which the start date has passed and the resource or right concerned has not been picked up by the requesting user, the company 200 can operate to cancel the loan by manipulating the loans page 284 in a manner similar to that described for processing the return of an item.

To request a loan of a resource or right of another user, the company 200 first accesses the assets page 290 via “network assets” side tab 248. Assets page 290 shows the resources and rights available for loan by the company 200, as determined by the underlying database rules and structures 102 and as determined by the category associated with selected tab 226. In respect of each resource and/or right, the following information is displayed:
a description of the resource or right;
its status;
the owner's name;
the association path through which the resource or right has been deemed available for loan; and
the general location of the resource or right.

The company 200 may seek to restrict the resource or rights displayed by way of a filter or search criteria.

Once the resource or right to be loaned has been identified from those displayed, the company 200 clicks on the description of the item. This opens an external loan page 292.

External loan page 292 operates in an identical manner to additional information page 256 except for the following modifications:
details of the resource or right to be loaned, as recorded by the owner of the resource or right, are displayed in place of the additional information to be hidden. Such details may include a graphical picture of the resource or right; and
the calendar 258 can only be used to make an external loan to another user—the functionality for reserving the resource or right for the owner and the functionality for making a loan to an external party, not being a user of the system 10 is omitted from the external loan page 292.

To facilitate co-ordinated purchasing of assets, the company 200 can access a guide page 294. Guide page 294 is accessed via the “buyer's guide” side tab 248.

Guide page 294 shows results of all items as specified in data fields 296. Items are restricted firstly by way of the category associated with the selected tab 226. Data field 296 allows the company to specify the appropriate sub-category, as recorded by data fields 228, from the data fields 296. Other restrictive search criteria can be recorded in the remaining sub-category.

On identifying the desired item, the company 200 clicks on the description of the asset to bring up buy/recommend page 298. Buy/recommend page displays further details of the item and allows the company 200 to record suggestions for changes to the description of the item. In this manner, the company 200 or any other user can attend to corrections of misclassifications of an item and identify those items that should have an appropriate warning attached thereto (such as age restriction warnings).

The company 200 may, if it so wishes, seek to purchase the item from a preferred supplier. In such a situation, a link 300 to the preferred supplier is provided to facilitate such purchase.

As an alternative to direct purchase, the company 200 may recommend the item for purchase by another user. This is done by pressing push button 302 and opening recommendation page 304.

Recommendation page 304 provides a list of all users with whom the company 200 has a direct or indirect relationship. Each user has an associated checkbox 306. For those users to whom the company 200 wishes to send the recommendation, associated checkbox 306 is selected. Recommendations are sent to each selected user as an e-mail with a hyperlink back to the preferred supplier to facilitate their purchase.

Using text field 308, the company 200 may customise the recommendation. In this manner, the company 200 can seek to co-ordinate purchasing by specifying those assets to be purchased. Alternatively, for example in a situation where the company 200 is organising attendance at a conference or event on behalf of its social club, the invitation may seek expressions of interest from the other users so that a group booking can be made (with the associated saving being passed on to each user who takes up the offer).

It should be appreciated by the person skilled in the art that the present invention is not limited to the embodiments described above and that additions and modifications thereto fall within the scope of the invention. In particular:
Prior to sending an invitation e-mail to a potential company, the system 10 may check to see how many invitation e-mails have previously been sent to the potential user. If the number of invitation e-mails previously sent exceeds a predetermined number within a predetermined time period, the system 10 then refrains from sending a further invitation e-mail to that potential user.
Invitation e-mails may be customised. If no customisation occurs, the invitation e-mail will default to a standard textual description of the system 10. Further the company 200 can set the value of any association subsequently formed by way of the invitation e-mail prior to sending.
Details of new resources and/or rights can be added in a multitude of ways. As a first alternative, details of new resources and/or rights may be added by means of selections and/or data input by the company 200 with no recourse to resource or rights lists. In a second alternative, the system 10 may incorporate one or more identification readers, each identification reader adapted to read an identification tag attached or associated with the new resource or right. For example, the identification reader may be a barcode reader and the identification tag a barcode printed on the new resource or the packaging of the new resource.
In a yet further alternative arrangement, the system 10 may be integrated with a point-of-sale network. In this arrangement, details of resources or rights purchased by the point-of-sale network may be automatically forwarded to the system 10. To ensure that details of the new resource or right are recorded against the appropriate user, details of the user may need to be conveyed to the point-of-sale network from a loyalty card or similar user identifier.
User summary 232 may operate to display a certain number of associations, being the last associations formed by other users with company 200. Alternatively, user summary 232 may operate to display all associations formed by other users with company 200 since the company's last access of the system 10.
Calendar 258 may operate to show only current or future dates when the associated resource is on loan or otherwise used
Calendar 258 may operate to show additionally hours and minutes in the day to allow bookings by the hour or minute.
The information recorded in respect of a resource or right may be different to that mentioned above. For instance, further information such as age restriction, classification and other warnings may be attached to certain resources or rights. In the case of books, music and movies, this additional information may include a review of the book, music or movie as appropriate.
The system 10 may include information on the condition of a resource. In this manner, damage to the resource that occurs upon lending can be identified. This information may be tied in with a moral, if not legal, obligation on the part of the party who has caused the damage to make amend for the damage. This may be in accordance with a compensation framework implemented as part of the system 10.
As it is possible that asset lists may have multiple or similar items recorded thereon, there is the possibility that a user may not be able to instantly recognise which resource or right accords with the resource or right that they possess. Accordingly, the system 10 may allow for a user to view further details, and possibly a visual representation of the resource or right before confirming that it represents the resource or right that they possess. This may be achieved by including a hyperlink to such information.
Users may be able to define their own categories and sub-categories of resources and/or rights.
Resources and/or rights set an association level that indicates that they are reserved for the owner may still be viewed by other entities.
Searching for resources and/or rights may be conducted on a variety of fields. Similarly, reporting can be conducted on a variety of fields.

The applicant envisages that initial reporting will include at least the following:
a report on resources and/or rights by category;
a report on resources and/or rights presently on loan;
the loan history of a user;
a list of users in the network with whom an association exists (up to a pre-specified association level); and
preparation of a list of resources and/or rights for insurance purposes.
The system 10 may be modified to allow operation on such other communication devices as personal digital assistants and wireless application protocol- enabled devices
Users may combine a personal website with their resource and/or right information.
The system 10 may be modified for internal use by a company. In such an arrangement the system may be white-labelled to meet corporate image requirements. Further, deletion of assets in such an arrangement may only be able to be attended to by an authorised party to prevent possible fraud and facilitate proper auditing of assets of the company.
As mentioned above, users are able to specify a resource and/or right as available for swapping or buying. Such resources and/or rights may be “open-market” information available to everyone on the system. The system 10 may also include mechanisms to further facilitate the integrity of any swap or purchase between users.
The mechanism by which a loan is recorded within the system 10 may be modified from that mentioned above. For example, a “shopping-basket” like loan arrangement may be implemented.
Other features, such as providing comments on a user's experience with other users, discussion lists and chat rooms may also be implemented into the system.
The transfer mechanism mentioned above need not require a date to specify and may be implemented on a “real-time” basis—i.e. when steps are taken to record the transfer it is presumed that the asset concerned has been transferred to the other user.
The system may incorporate asset distributions. This allows a resource and/or right to be collected and returned, i.e. “picked up” and “dropped off”, at one or more independent and secure locations. The references herein to a resource and/or a right also encompass arrangements where a resource or right is a subset of another group of resources and/or rights. For example, the case of a resource being a spare part which is a component, or subset, of a complete unit (which may also be considered as a resource in the present invention).
A reference to a resource also encompasses a fixed entity or a system such as a business process that has available capacity as well as a skilled person. The reference to a resource in the context of the present invention also encompasses resources being electronic files that may be shared over the internet or, within a company or organisation, over the intranet of that company/organisation.
In the situation where a warranty is associated with a resource that has been selected by a user, the system may also incorporate a facility whereby a reminder regarding the renewal of that warranty is sent, at a selected time, to the user who selected the resource.

It should be further appreciated by the person skilled in the art that features and modifications discussed above, not being alternatives or substitutes, can be combined to form yet other embodiments that fall within the scope of the invention described.

1. A system for managing resources and/or rights comprising:
a set of entities, each entity of the set having an association with at least one other entity of the set;and a set of resources and/or rights possessed or controlled by each entity,
wherein a first entity of the set of entities determines the subset of resources and/or rights possessed by the first entity that another entity may use or view details of, based on the minimum number of associations that exist between the first entity and the other entity.

2. A system for managing resources and/or rights according to claim 1, where each resource or right in the set of resources and/or rights is allocated an association level, such that entities having a minimum number of associations that exist between the first entity and the other entity in excess of the association level can not use or view details of that resource or right.

3. A system for managing resources and/or rights according to claim 2, where the association level can be set to a value representing that the corresponding resource or right is a private resource or right such that the other entities in the set of entities are unable to use or view details of that resource or right.

4. A system for managing resources and/or rights according to claim 2, where the association level has a value representing that, for the other entity to be able to use or view the resources and/or rights of the first entity, the number of associations that exist between the first entity and the other entity does not exceed a selected number.

5. A system for managing resources and/or rights according to claim 1, where each entity in the set of entities has an exclusion list, such that entities included on the exclusion list are not able to use or view the resources and/or rights of that entity irrespective of the number of associations that exist between that entity and the other entity.

6. A system of managing resources and/or rights according to claim 5, where each entity is not able to use or view the resources and/or rights of each entity included on their respective exclusion list irrespective of the number of associations that exist between that entity and the other entity.

7. A system of managing resources and/or rights according to claim 1, where each association has a weighting value, and the other entity may use or view resources and/or rights of the first entity having an association level greater than or equal to the minimum sum of weighting values of the number of associations that exist between the first entity and the other entity.

8. A system of managing resources and/or rights according to claim 2, where each resource or right in the set or resources and/or rights has at least two association levels, has at least two weighting values, the other entity may use resources and/or rights of the first entity having a first association level greater than or equal to the minimum number of associations that exist between the first entity and the other entity and where the other entity may view resources and/or rights of the first entity having a second association level greater than or equal to the minimum number of associations that exist between the first entity and the other entity.

9. A system of managing resources and/or rights according to claim 8, where each association has at least two weighting values, and where the other entity may use or view resources and/or rights of the first entity having an association level greater than or equal to the minimum sum of first weighting values of the number of associations that exist between the first entity and the other entity and the first entity may use or view resources and/or rights of the other entity having an association level greater than or equal to the minimum sum of second weighting values of the number of associations that exist between the other entity and the first entity.

10. A system of managing resources and/or rights according to claim 8, where each resource or right in the set of resources and/or rights has at least two association levels and where each association has to least two weighting values, the other entity may use resources and/or rights of the first entity having a first association level greater than or equal to the minimum sum of third weighting values of the number of associations that exist between the first entity and the other entity and where the other entity may view resources and/or rights of the first entity having a second association level greater than or equal to the minimum sum of fourth weighting values of the number of associations that exist between the first entity and the other entity.

11. A system of managing resources and/or rights according to claim 8, where, if there is a direct association between the first entity and the other entity, the minimum sum of weighting values between the first entity and the other entity is equal to the weighting value allocated to the direct association.

12. A system of managing resources and/or rights according to claim 8, where a first entity may exclude another entity from using or viewing its resources and/or rights by creating a direct relationship between the first entity and the other entity having a weighting value in excess of the maximum sum of weighting values the system traverses in determining the set of resources and/or rights that the other entity may use or view.

13. A system of managing resources and/or rights according to claim 8, where a first entity may exclude another entity from using or viewing its resources and/or rights, where, on excluding the other entity, all other entities having an association with the first entity solely via the excluded other entity are also excluded from using or viewing the first entity's resources and/or rights.

14. A user interface for a system of managing resources and/or rights according to claim 1, the user interface including:
means for displaying the resources and/or rights that a user can view or use; and
means for recording a request by the user to use a displayed resource or right.

15. A user interface according to claim 14, including asset recording means to add a resource and/or right to the system, the asset recording means operable to receive a predetermined set of information and, using at least a portion of the predetermined set of information, reference a resource list to obtain a set of assets which substantially correspond to the portion of the predetermined set of information, the user thereafter able to choose the resource and/or right from the set of assets.

16. A user interface according to claim 14, where the asset recording means operates to record a set of additional information in respect of each resource and/or right, a subset of the additional information not able to be viewed by other entities.

17. A user interface according to claim 14, where the asset recording means includes a reader, the reader operable to read a unique identifier of a resource and referencing the unique identifier against a unique identifier database, obtain a predetermined set of details in respect of the resource.

18. A user interface according to claim 14, where the asset recording means is a point of sale terminal incorporating a card reader, the card reader operable to read an identification card of a user and, with reference to identification information included on the identification card, record details of all resources and/or rights purchased with the system as resources and/or rights of the user.

19. A user interface according to claim 14, where each resource includes condition information.

20. A user interface according to claim 14, including a calendar, the calendar operable to display information as to the availability of a selected resource or right.

21. A user interface according to claim 20, wherein the calendar is operable to display information as to the date, time and duration that a selected resource or right is available, or unavailable, to be used.

22. A user interface according to claim 14, operable to send a series of reminders to an entity using a resource and/or right of the user following expiry of a loan period set by the entity and approved by the user, the series of reminders to continue until such time as the user records the resource and/or right as having been returned.

23. A user interface according to claim 14, further including means for processing a request, confirmation and return by the user for the use of a displayed resource or right for a loan period.

24. A user interface according to claim 14, including transfer means for transferring a resource and/or right between the user and an entity, the transfer means further operable to transfer any requests to use the resource and/or right along with the resource and/or right.

25. A user interface according to claim 14, including invitation means for a first entity to invite a second entity to join the system, where, upon the second entity joining the system, a direct relationship is established between the first entity and the second entity.

26. A user interface according to claim 25, where the invitation means checks to see whether the second entity has been invited to join the system more than a predetermined number of times within a predetermined time period and, if so, does not send an invitation to the second entity to join the system.

27. A user interface according to claim 14, including summarising means for displaying at least one of the following: the number of resources and/or rights presently loaned to the user; the number of resources and/or rights presently loaned by the user; the number of resources and/or rights possessed by the user; the number of resources and/or rights possessed by the user by location.

28. A user interface according to claim 27, where the information displayed by the summarising means is further restricted to those resources and/or rights that fall within a category chosen by the user.

29. A user interface according to claim 14, where the user may convey to at least one other entity an item that they wish to possess, control or borrow.

30. A user interface according to claim 14, where the user interface includes a personal website of the user, the user interface further operable to display the personal website to other entities of the system.

31. A storage medium for software for implementing a system for managing resources and/or rights according to claim 1.

32. A storage medium for software for implementing a user interface according to claim 14.

33. A data processing apparatus having software for implementing a system for managing resources and/or rights according to claim 1 stored in a memory thereof.

34. A data processing apparatus having software for implementing a user interface according to claim 14 stored in a memory thereof.

35. A data processing apparatus according to claim 33, where said data processing apparatus is a personal digital assistant, mobile phone, wireless application protocol enabled device or other communication device.

36. A method of managing resources and/or rights comprising the step of determining the subset of resources and/or rights of the set of resources and/or rights possessed by a first entity that another entity may use or view based on the minimum number of associations that exist between the first entity and the other entity.

37. A method of managing resources and/or rights according to claim 36, including the step of allocating an association level to each resource or right in the set of resources and/or right; and where the step of determining the subset of resources and/or rights that another entity may use or view includes only those resources and/or rights that have an association level equal to or higher than the minimum number of associations between the first entity and the other entity.

38-44. (canceled)
